(19) United States
(12) Patent Application Publication
(10) Pub. No.: US 2026/0368694 A1
(43) Pub. Date: Nov. 19, 2026

(54) METHOD AND SYSTEM FOR AUTOMATIC VENDING MACHINE INVENTORY MANAGEMENT WITH AUTO PLANOGRAM GENERATION

(71) Applicant: Verizon Patent and Licensing Inc., Basking Ridge, NJ (US)

(72) Inventors: Magesh Koteeswaran, Tamil Nadu (IN); Arun Prabhu Selvaraj, Little Elm, TX (US); Senthil Muthusamy, Frisco, TX (US); Srinivasa Rao Kella, Princeton, NJ (US); Grady R. Milhon, Keller, TX (US); Damodharan Sundararajan, Monroe, NJ (US)

(73) Assignee: Verizon Patent and Licensing Inc., Basking Ridge, NJ (US)

(21) Appl. No.: 19/301,317

(22) Filed: Aug. 15, 2025

Related U.S. Application Data
(63) Continuation-in-part of application No. 19/206,265, filed on May 13, 2025.

(51) Int. Cl. G06Q 10/087; G06K 7/14

(52) U.S. Cl. CPC G06Q 10/08724; G06K 7/1417; G06Q 10/0877

(57) ABSTRACT

One or more computing devices, systems, and/or methods are provided. A system for automatic planogram creation in a vending machine may be provided. In response to an instruction, an automated process may be initiated where a sensor coupled to a movable component scans a plurality of storage locations within the vending machine. At each location, a reading is collected to determine if an item is present. If an item is present, an item identifier and an item size are determined from the reading. A planogram is then generated that maps the determined item identifiers and sizes to their respective storage location coordinates. The generated planogram is then stored for use in inventory management.

### RELATED APPLICATIONS

This application is a continuation-in-part of U.S. patent application Ser. No. 19/206,265, filed on May 13, 2025 and titled “METHOD AND SYSTEM FOR AUTOMATIC VENDING MACHINE INVENTORY MANAGEMENT”, the contents of which are hereby incorporated herein by reference.

### BACKGROUND

Vending machines may dispense products like electronics, snacks, beverages, and other goods when a user makes a selection and payment. They are commonly found in public places including stores, offices, malls, etc.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating an example system for providing inventory management services for a vending machine, according to some embodiments.

FIG. 1B is a diagram illustrating an example system for providing inventory management services for a vending machine, where an interface panel displays an item selection interface, a plan selection interface and/or a payment interface, according to some embodiments.

FIG. 1C is a diagram illustrating an example system for providing inventory management services for a vending machine, where an inventory profile is generated, according to some embodiments.

FIG. 1D is a diagram illustrating an example system for providing inventory management services for a vending machine, where a reading of a storage location is collected using a sensor, according to some embodiments.

FIG. 1E is a diagram illustrating an example system for providing inventory management services for a vending machine, where an inventory status of a storage location is determined based upon a reading and a planogram, according to some embodiments.

FIG. 1F is a diagram illustrating an example system for providing inventory management services for a vending machine, where a reading of a storage location is collected using a sensor, according to some embodiments.

FIG. 1G is a diagram illustrating an example system for providing inventory management services for a vending machine, where an alert indicative of an inventory issue is transmitted to a vendor device, according to some embodiments.

FIG. 1H is a diagram illustrating an example system for providing inventory management services for a vending machine, where a vending machine administration interface is displayed on a vendor device, according to some embodiments.

FIG. 1I is a diagram illustrating an example system for providing inventory management services for a vending machine, where an interactive planogram representation is displayed on a vendor device, according to some embodiments.

FIG. 1J is a diagram illustrating an example system for providing inventory management services for a vending machine, where a hopper is moved to a target position relative to an item to be retrieved for a user, according to some embodiments.

FIG. 1K is a diagram illustrating an example system for providing inventory management services for a vending machine, where an item is transferred to a dispensing location, according to some embodiments.

FIG. 2 is a flow chart illustrating an example method for providing inventory management services for a vending machine, according to some embodiments.

FIG. 3 is a flow chart illustrating an example method for providing inventory management services for a vending machine, according to some embodiments.

FIG. 4 is a flow chart illustrating an example method for providing inventory management services for a vending machine, according to some embodiments.

FIG. 5 is a diagram illustrating an example system to facilitate one or more operations of a vending machine, according to some embodiments.

FIG. 6 is an illustration of a scenario featuring an example non-transitory machine readable medium, according to some embodiments.

FIG. 7 is a flow chart illustrating an example method for providing automatic payment reversal in a vending machine, according to some embodiments.

FIG. 8 is a flow chart illustrating an example method for providing automatic planogram creation for a vending machine, according to some embodiments.

FIG. 9 is a diagram illustrating an example system for providing automatic planogram creation with vendor interaction, according to some embodiments.

FIG. 10 is a diagram illustrating an example user interface on a vendor device for editing a preliminary planogram, according to some embodiments.

FIG. 11 is a flow chart illustrating an example method for providing automatic planogram creation with vendor interaction via a vendor application, according to some embodiments.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion. The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques are provided herein for automatically providing inventory management services for a vending machine. Readings of storage locations of the vending machine may be collected using a sensor, for example, a camera coupled to a hopper and/or robotic arm used to perform the item retrieval process. The readings may be analyzed to determine item identifiers of items stored in the storage locations. The item identifiers may be cross checked with entries of a planogram to identify an inventory issue, and one or more corrective actions may be performed to address the inventory issue. Automated identification of inventory issues, such as misplaced items and/or out-of-stock conditions, may improve accuracy, reduce labor, and/or facilitate timely corrective actions.

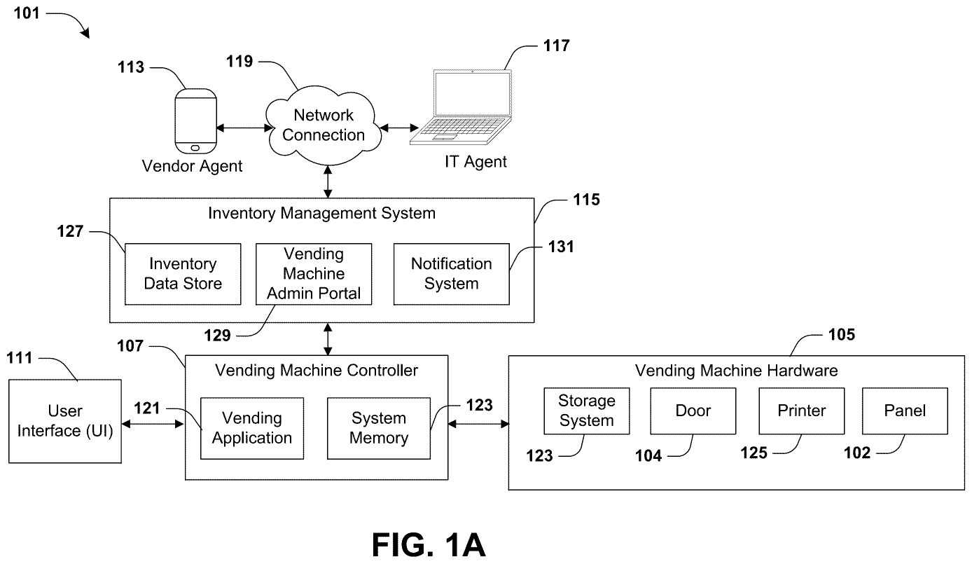

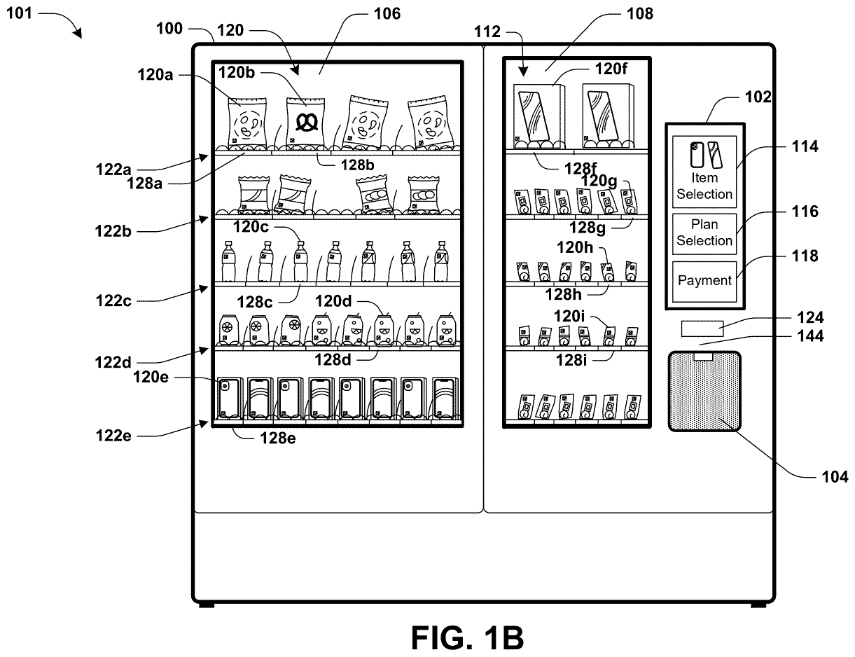

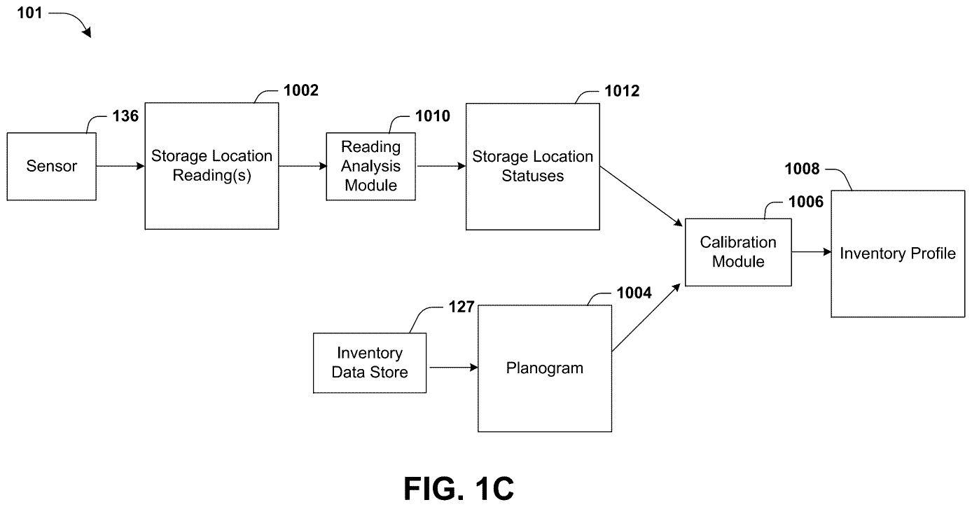

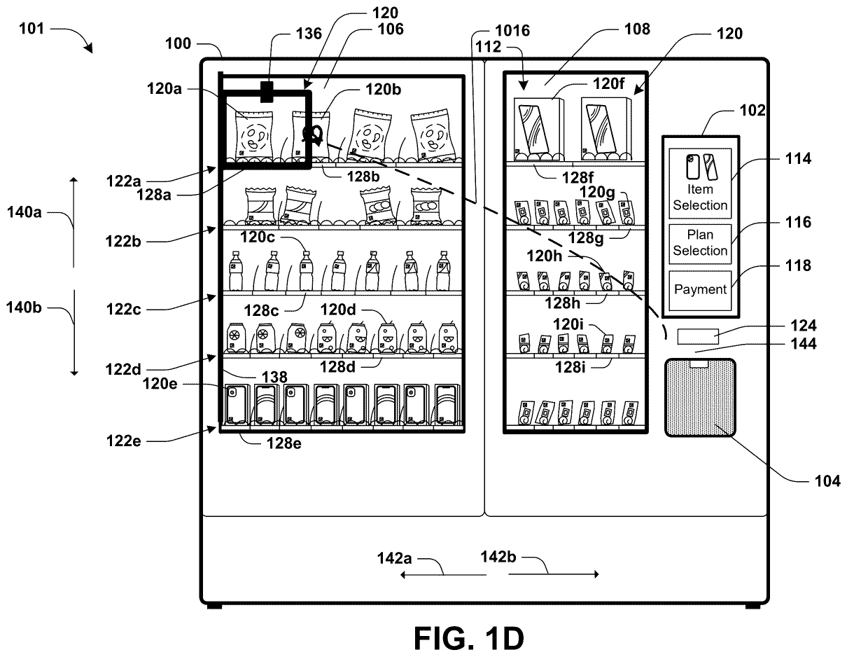

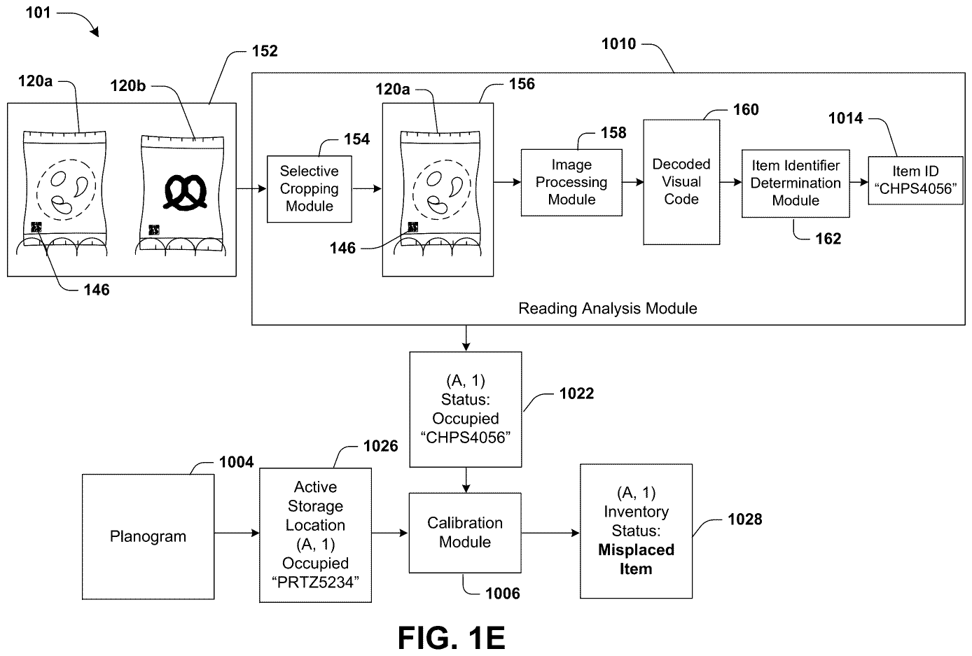

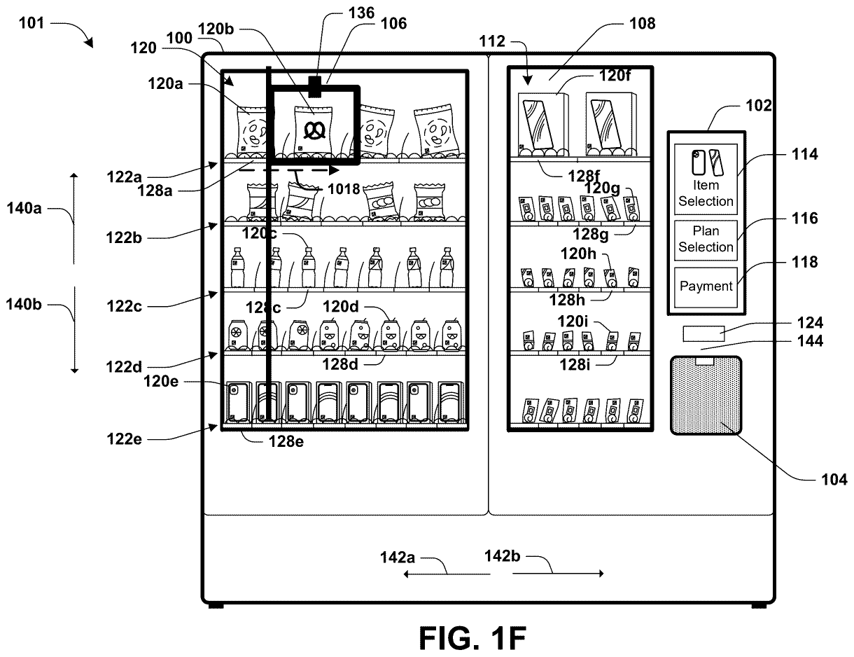

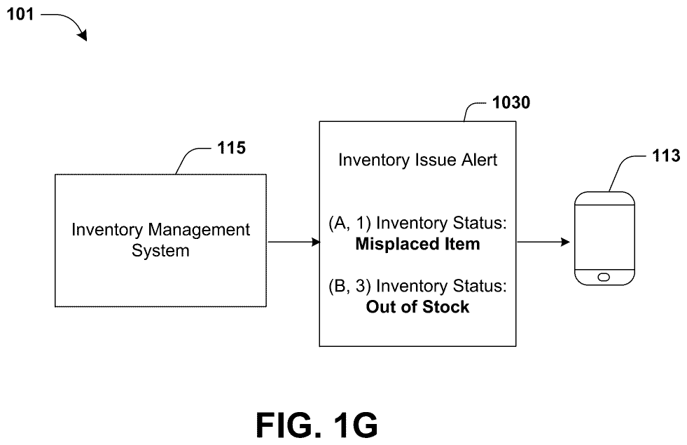

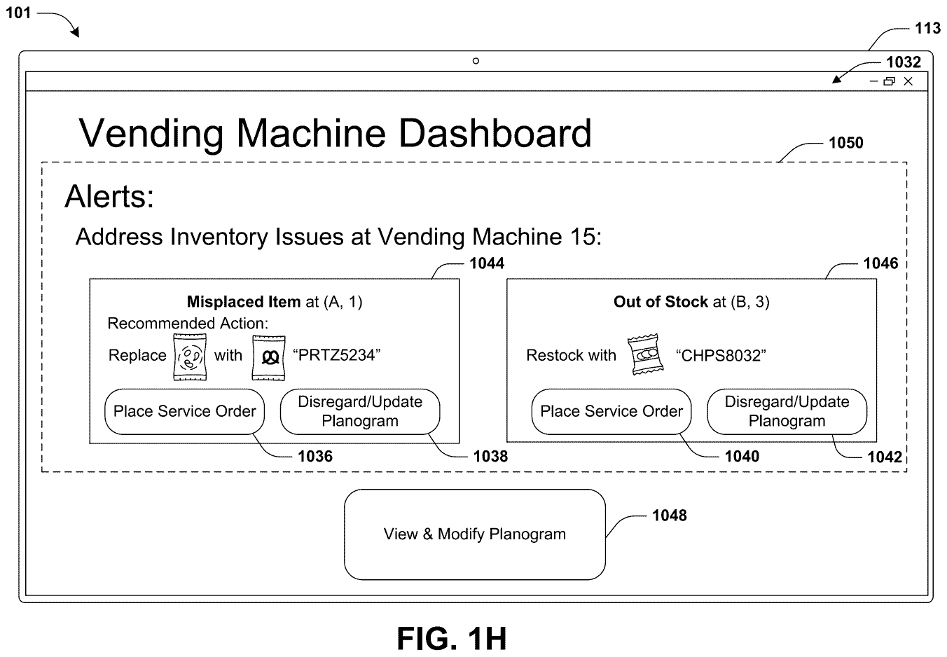

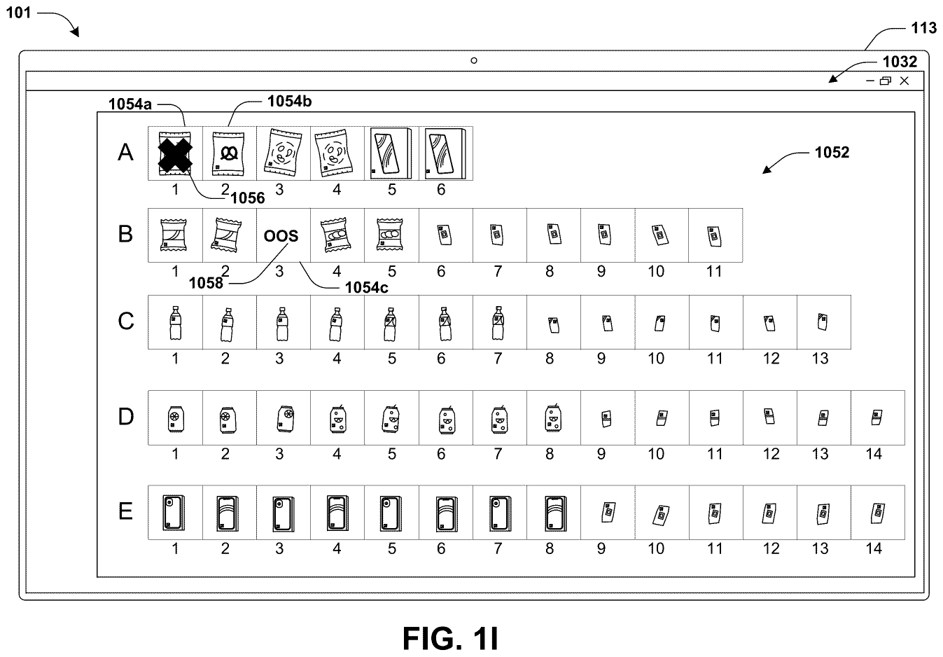

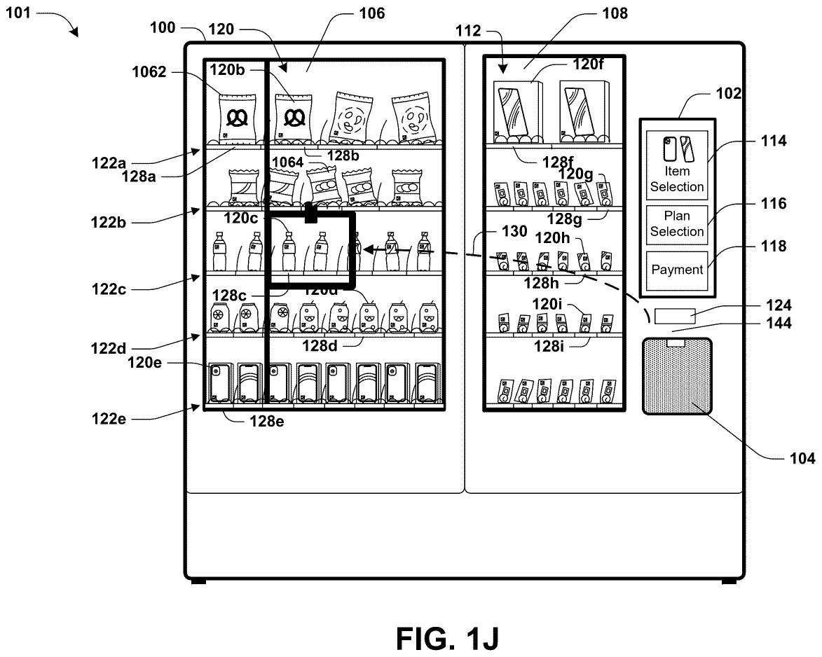

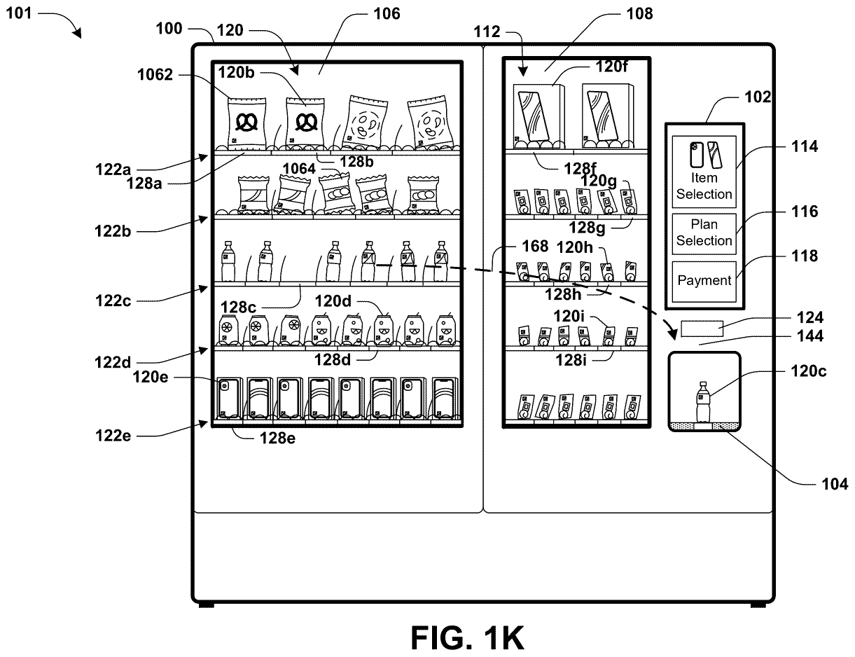

FIGS. 1A-1K illustrate examples of a system 101 for automatically providing inventory management services for one or more vending machines, such as a vending machine 100. FIG. 1A illustrates components of the system 101 including an inventory management system 115 providing one or more vending machine services including one or more inventory management services, vending machine hardware 105 of the vending machine 100 and/or a vending machine controller 107 to control the vending machine hardware 105 and/or interact with the inventory management system 115. The vending machine hardware 105 may comprise a storage system 123, a dispensing slot door 104, a printer 125, an interface panel 102 and/or one or more other components. The vending machine controller 107 may provide a user interface 111 for display on the interface panel 102. The user interface 111 may be used for item selection, payment, and/or other actions associated with the vending machine 100.

In some examples, the inventory management system 115 may provide one or more vendor services to a vendor device 113 (e.g., a smartphone, a tablet, a laptop, etc. associated with a vendor agent). The vendor services may comprise services for managing, modifying and/or keeping track of inventories and/or other parameters associated with a set of vending machines (e.g., a set of one or more vending machines) associated with the vendor agent (e.g., the vendor agent may be an owner and/or management entity associated with the set of vending machines). The set of vending machines may comprise the vending machine 100 and/or one or more other vending machines.

In some examples, the inventory management system 115 may comprise an inventory data store 127 (e.g., a database) that may track and/or update inventory records for the set of vending machines, machine records for the set of vending machines, and/or other information associated with the set of vending machines. The inventory management system 115 may comprise a vending machine administration portal 129 that may provide the vendor device 113 with a vending machine administration platform (e.g., a mobile application, a web page, etc.) that provides access to one or more vending machine management services associated with the set of vending machines. For example, the vending machine administration portal 129 may authenticate the vendor agent and/or provide (controlled) access to resources associated with the set of vending machines in response to (successful) authentication. The inventory management system 115 may comprise a notification system 131, which may send alerts (e.g., out-of-stock alerts, item misplacement alerts, low-inventory alerts, etc.) to one or more vendor agents and/or the vendor device 113 via email, push notification, text message, a visual notification displayed on a vending machine administration interface 1032 (e.g., a dashboard) of the vending machine administration platform, etc.

In some examples, an Information Technology (IT) device 117 (e.g., a smartphone, a tablet, a laptop, etc. associated with an IT agent) may be used (by an IT agent, for example) to troubleshoot issues associated with the one or more vending machine services provided to the vendor device 113. The inventory management system 115 may be connected to the vendor device 113 and/or the IT device 117 via one or more network connections 113 (e.g., one or more encrypted connections).

FIG. 1B illustrates a front view of the vending machine 100. The vending machine 100 may comprise the interface panel 102 (e.g., a touchscreen panel), the dispensing slot door 104 to a dispensing slot, the storage system 123 with a plurality of storage locations for storing a plurality of items 120, and/or a hopper 134 (shown in FIG. 1D) for retrieving items selected and/or purchased by a user of the vending machine 100.

The vending machine 100 may comprise one or more viewing panels, such as a viewing panel 106 and/or a second viewing panel 108, which may provide a user with a view of some or all of the plurality of items 120. For example, the viewing panel 106 may comprise a transparent panel that provides visibility to a subset of storage locations of the plurality of storage locations and/or items stored in the subset of storage locations. The second viewing panel 108 may comprise a second transparent panel that provides visibility to a second subset of storage locations of the plurality of storage locations and/or items stored in the second subset of storage locations.

The storage system 123 may comprise racks on which items of the plurality of items are stored. The racks may be arranged in rows, such as rows 122a, 122b, 122c, 122d and/or 122e. Other quantities of rows of the storage system 123 of the vending machine 100 other than five rows (e.g., more or less than five rows) are within the scope of the present disclosure. In some examples, one or more of the racks may be fixed. In some examples, one or more of the racks may be adjustable (e.g., the storage system 123 may comprise one or more adjustment mechanisms to allow for modification of height, angle, spacing, etc. of a rack to accommodate different item sizes). The racks may be equipped with dividers, bins, and/or guiding rails to keep items properly aligned and/or prevent items from shifting during machine operation. In some examples, the storage system 123 may comprise gravity-fed sloped racks that allow items to slide forward for easy retrieval and/or a motorized push mechanism that advances an item of the plurality of items 120 to a dispensing position (and/or into the hopper 134 when the item is being collected, for example). In some examples, the storage system 123 may comprise a spring-loaded platform and/or an elevator-based mechanism that helps lift and/or position an item for retrieval (using the hopper 134, for example). In some examples, the storage system 123 may comprise a rotating carousel and/or conveyor-based system configured to transport items to an access point. In some examples, the storage system 123 may comprise sensors, weight-detection platforms and/or robotic arms to monitor an item for improper item positioning and/or reposition the item (using the robotic arm, for example) in response to determining that the item is improperly positioned, thereby facilitating smooth dispensing operations of the vending machine 100.

In some examples, the plurality of items 120 may comprise one or more item types. For example, the plurality of items 120 may comprise electronics (e.g., phones, such as smartphones and/or other type of phones, tablets, SIM cards, wearable devices, such as a smartwatch, smart earphones, and/or smart glasses, power banks, headphones, and/or other types of electronics, etc.), drinks (e.g., soda, water, juice, energy drinks, coffee, etc.), snacks (e.g., chips, candy bars, granola bars, nuts, cookies, etc.), fresh food (e.g., sandwiches, salads, wraps, etc.) frozen food (e.g., ice cream, microwaveable meals, etc.), health and/or wellness products (e.g., first aid kits, bandages, antiseptic wipes, gauze, small first aid kits, vitamins, sleep aids, motion sickness drugs, etc.), over-the-counter medicine (e.g., pain relievers, allergy pills, cold and/or flu remedies, etc.), personal hygiene items (e.g., hand sanitizer, hygiene products, tissues, toothbrushes, toothpaste, shampoo, mouthwash, body wash, deodorant, etc.), and/or other types of items.

For example, the plurality of items 120 may comprise an item 120a (e.g., a bag of chips), a second item 120b (e.g., a bag of pretzels), a third item 120c (e.g., a bottle of juice), a fourth item 120d (e.g., a soda can), a fifth item 120e (e.g., a smartphone), a sixth item 120f (e.g., a tablet), a seventh item 120g (e.g., a wearable device, such as a smartwatch, smart earphones, smart glasses, etc.), an eighth item 120h (e.g., an IoT device, such as a meter, a GPS tracking unit, etc.), a ninth item 120i (e.g., a SIM card) and/or one or more other items of one or more other item types. The item 120a may be stored in a storage location over rack 128a, hereafter referred to as storage location “A, 1” to denote a row and/or column of the storage location, the second item 120b may be stored in a storage location over rack 128b, hereafter referred to as storage location “A, 2”, the third item 120c may be stored in a storage location over rack 128c, hereafter referred to as storage location “C, 3”, and/or the fourth item 120d, the fifth item 120e, the sixth item 120f, the seventh item 120g, the eighth item 120h, and/or the ninth item 120i may be stored in storage locations over racks 128d, 128e, 128f, 128g, 128h and/or 128i, respectively.

In some examples, the plurality of items 120 may comprise variants for one, some and/or all of the one or more item types. For example, the plurality of items 120 may comprise various brands and/or selections of drinks, snacks, fresh food, wellness products, etc. and/or phone variants (e.g., phones with differences in storage capacity, brand, model, telecommunication service compatibility which may indicate one or more telecommunication service providers that are compatible with the phone, software packages, etc.), tablet variants, SIM card variants, wearable device variants, and/or IoT device variants.

FIGS. 1C-1F illustrate aspects of a calibration process performed by the system 101 to determine inventory statuses associated with storage locations of the vending machine 100 and/or generate an inventory profile 1008 associated with the vending machine 100. FIG. 1C illustrates generation of the inventory profile 1008. The calibration process may comprise collecting storage location readings 1002 of storage locations of the storage system 123 using a sensor 136. The storage location readings 1002 may be analyzed by a reading analysis module 1010 (implemented by the inventory management system 115 and/or the vending machine controller 107, for example) to determine a plurality of storage location statuses 1012 associated with storage locations of the plurality of storage locations of the storage system 123. In some examples, the storage location readings 1002 comprises images captured by a camera and/or other types of readings. The plurality of storage location statuses 1012 may be provided to a calibration module 1006, which may generate the inventory profile 1008 based upon the plurality of storage location statuses 1012 and a planogram 1004 retrieved from the inventory data store 127. The planogram 1004 may map item identifiers and/or other information to storage locations of the plurality of storage locations of the storage system 123. The planogram 1004 may be used to keep track of which items are at which storage locations for the vending machine 100. For example, the calibration module 1006 may determine a plurality of inventory statuses associated with the associated with the storage locations by comparing the plurality of storage location statuses 1012 with entries of the planogram 1004, and/or may generate the inventory profile 1008 to be indicative of the plurality of inventory statuses and/or one or more inventory issues (e.g., misplaced item, out-of-stock item, etc.) indicated by one or more of the plurality of inventory statuses.

In some examples, items of the plurality of items 120 may be labeled with visual codes (e.g., Quick Response (QR) codes and/or other types of codes) that each may identify a corresponding item and/or may be used to determine an item identifier and/or other information associated with the corresponding item, such as type, brand, item type, price, model, storage capacity, telecommunication service compatibility, etc. In some examples, the sensor 136 may comprise a camera to scan visual codes of the plurality of items 120. In some examples, the camera may face the items (and/or racks of the storage system 123 and/or a back panel of the vending machine 100) such that an image captured by the camera has a view of one or more items stored in the vending machine 100.

In some examples, the camera may be coupled to a moveable component, such as the hopper 134, that moves the camera throughout the vending machine 100 such that the camera may capture images with views of various storage locations of the plurality of storage locations (and/or various items stored throughout the various storage locations). For example, the moveable component (e.g., the hopper 134) may move the camera to a target camera position relative to the storage location “A, 1” (e.g., a position of the camera where the camera has a view of at least a portion of the item 120a stored in the storage location “A, 1”).

FIG. 1D illustrates the camera at the target camera position relative to the storage location “A, 1”. In some examples, the hopper 134 may move the camera to the target camera position by moving along a path 1016 from a hopper position (e.g., behind a panel 144 of the vending machine 100) to a second hopper position (e.g., the position of the hopper 134 in front of the item 120a shown in FIG. 1D). The hopper 134 may be attached to a post 138 (e.g., a vertical post). The hopper 134 may be moveably coupled to the post 138. In some examples, a driving mechanism (e.g., a motor, a pneumatic actuator, a belt and/or pulley system, etc.) may move the hopper 134 vertically (along directions 140a and/or 140b, for example) along the post 138 to move the camera and/or the hopper 134 to a desired vertical position relative to the storage location “A, 1”. In some examples, a second driving mechanism (e.g., a motor, a pneumatic actuator, a belt and/or pulley system, etc.) may move the post 138 horizontally (along directions 142a and/or 142b, for example) to move the camera and/or the hopper 134 to a desired horizontal position relative to the storage location “A, 1”. In some examples, the hopper 134 may be moved along the path 1016 using the driving mechanism and/or the second driving mechanism.

In some examples, the camera may capture an image 152 (shown in FIG. 1E) of the storage location “A, 1”. For example, the vending machine controller 107 may activate the camera and/or trigger the camera to capture the image 152 in response to determining that the camera is at the target camera position relative to the storage location “A, 1”. In some examples, in response to capturing the image 152 using the camera, one or more operations may be performed (e.g., by the inventory management system 115, for example) to determine a storage location status 1022 (shown in FIG. 1E) and/or an inventory status 1028 associated with the storage location “A, 1”. The storage location status 1022 may be determined by analyzing the image 152 to determine whether an item is stored in the storage location “A, 1” and/or decode a visual code 146 (shown in FIG. 1E) associated with the item (e.g., the item 120a). In some examples, the visual code 146 may comprise a QR code, a barcode, a set of numbers, symbols and/or letters, etc. labeled and/or printed on packaging of the item 120a.

FIG. 1E illustrates use of the image 152 to determine the storage location status 1022 and/or the inventory status 1028 associated with the storage location “A, 1”. The image 152 may be provided to the reading analysis module 1010, which may use an image processing module 158 and/or a selective cropping module 154 to analyze the image 152 (e.g., using one or more AI image processing techniques for example) to identify the visual code 146 in the image 152, and/or to decode the visual code 146 to generate a decoded visual code 160. In some examples, the decoded visual code 160 may be provided to an item identifier determination module 162 of the reading analysis module 1010, which may use the decoded visual code 160 to determine an item identifier 1014 associated with the item 120a.

In some examples, the image 152 has a view of more than one storage location, such as both the storage location “A, 1” (in which the item 120a is stored) and the storage location “A, 2” (in which the second item 120b is stored). For example, the field of view of the camera is such that one or more other storage locations are visible when the camera is positioned for imaging the storage location “A, 1”. In some examples, the selective cropping module 154 may be used to identify a target item (e.g., the item 120a) among multiple items in the image 152 and/or crop the image 152 to generate a cropped image 156 excluding at least a portion of the second item 120b. In some examples, the selective cropping module 154 may be used to identify a target storage location (e.g., the storage location “A, 1”) among multiple storage locations (e.g., storage locations “A, 1” and “A, 2”) depicted in the image 152, and/or generate the cropped image 156 to comprise a portion of the image 152 corresponding to the target storage location. The selective cropping module 154 may identify the target item and/or the target storage location based upon a position of the target item and/or the target storage location relative to a field of view (FoV) of the image 152. For example, the selective cropping module 154 may select an item and/or storage location closest to a center (or other predefined location) of the FoV of the image 152 as the target item and/or the target storage location. In some examples, the selective cropping module 154 may perform a verification process to verify that the identified item matches one or more expected characteristics of the target item, such as predefined shape, predefined size, and/or visual code presence, before finalizing the selection of the item 120a as the target item and/or performing the cropping operation to generate the cropped image 156 with the target item (e.g., the item 120a). The cropped image may be provided to the image processing module 158 to identify the visual code 146 in the cropped image 156, and/or to decode the visual code 146 to generate a decoded visual code 160.

The item identifier determination module 162 may determine the item identifier 1014 based upon the decoded visual code 146. In some examples, the decoded visual code 146 comprises the item identifier 1014. In some examples, the item identifier determination module 162 transmits a request indicative of the decoded visual code 146 to an item identification system that provides the item identifier determination module 162 with the item identifier 1014 in response to the request. In some examples, the item identifier 1014 may comprise a stock-keeping unit (SKU) associated with the item 120a, a vendor identifier associated with the item 120a, an International Mobile Equipment Identity (IMEI) associated with the item 120a, and/or an Integrated Circuit Card Identifier (ICCID) and/or Embedded Universal Integrated Circuit Card (eUICC) Identifier (EID) associated with the item 120a.

In some examples, the reading analysis module 1010 may generate the storage location status 1022 to be indicative of whether the storage location “A, 1” is occupied or vacant, and/or the item identifier 1014 of the item 120a stored in the storage location “A, 1”. The storage location status 1022 may be provided to the calibration module 1006, which may determine the inventory status 1028 associated with the storage location “A, 1” based upon the storage location status 1022 and/or a storage location entry 1026 associated with the storage location “A, 1” from the planogram 1004. In some examples, the planogram 1004 may comprise a plurality of storage location entries associated with the plurality of storage locations. For example, each of the plurality of storage location entries may be indicative of a representation of a corresponding storage location (e.g., the storage location “A, 1” may be represented as “A, 1” in the planogram 1004), whether the corresponding storage location is active or inactive, and/or an item identifier of an item to be stored in the corresponding storage location.

The calibration module 1006 may analyze the planogram 1004 to identify the storage location entry 1026 from among the plurality of storage location entries associated with the plurality of storage locations. The storage location entry 1026 may indicate that the storage location “A, 1” is designated an active storage location (e.g., a storage location that is currently expected to be occupied) and/or that the storage location “A, 1” is assigned to an item (e.g., a bag of pretzels) associated with item identifier “PRTZ5234”. The calibration module 1006 may compare the storage location status 1022 with the storage location entry 1026 to check for a discrepancy, such as a difference in vacancy status or item between the storage location status 1022 and the storage location entry 1026. In response to identifying a discrepancy, the calibration module 1006 may generate the inventory status 1028 to be indicative of the discrepancy. For example, in response to determining that the item identifier 1014 (e.g., “CHPS4056”) indicated by the storage location status 1022 is different than the item identifier (e.g., “PRTZ5234”) indicated by the storage location entry 1026 of the planogram 1004, the calibration module 1006 may generate the inventory status 1028 to be indicative of an item discrepancy (e.g., a misplaced item where the bag of chips is mistakenly stored in the storage location “A, 1” instead of the bag of pretzels indicated by the planogram 1004).

In some examples, in response to capturing the image 152, the camera may be moved to other positions to collect other images of other storage locations of the plurality of storage locations. For example, the camera may be moved to a second target camera position relative to the storage location “A, 2” (where the second item 120b is stored, for example). FIG. 1F illustrates the hopper 134 moving along a path 1018 from the second hopper position to a third hopper position to move the camera to the second target camera position (e.g., in front of the storage location “A, 2” and/or the second item 120b). In some examples, the hopper 134 may be moved along the path 1018 using the driving mechanism and/or the second driving mechanism.

The camera may capture a second image of the storage location “A, 1”. For example, the vending machine controller 107 may activate the camera and/or trigger the camera to capture the second image in response to determining that the camera is at the second target camera position relative to the storage location “A, 2”. In some examples, in response to capturing the second image using the camera, the reading analysis module 1010 may determine a second storage location status of the plurality of storage location statuses 1012 based upon the second image, such as using one or more of the techniques provided herein with respect to determining the storage location status 1022. For example, the second storage location status may be indicative of whether the storage location “A, 2” is occupied or vacant, and/or a second item identifier of the second item 120b stored in the storage location “A, 2” (which may be determined by the reading analysis module 1010 based upon a visual code, such as a QR code, identified in the second image of the second item 120b). The calibration module 1006 may determine a second inventory status of the plurality of inventory statuses based upon the second storage location status and/or the planogram 1004, such as using one or more of the techniques provided herein with respect to determining the inventory status 1028. For example, the second inventory status may be indicative of whether the storage location “A, 2” is associated with an inventory issue, which may be determined by comparing the second storage location status with a second storage location entry (associated with the storage location “A, 2”) from the planogram 1004 to check for a discrepancy (e.g., a difference in vacancy status or item) between the second storage location status and the second storage location entry. In some examples, the second inventory status may indicate that the storage location “A, 2” is not associated with an inventory issue based upon a determination that information (e.g., the second item identifier) indicated by the second storage location status matches information (e.g., an expected item identifier) indicated by the second storage location entry.

In some examples, the calibration process may comprise moving the sensor 136 (e.g., the camera) to various target positions and/or collecting readings (e.g., images) of storage locations until the storage location readings 1002 include readings for some and/or all storage locations of the storage system 123. In some examples, the storage location readings 1002 comprise storage location readings for storage locations that are designated active by the planogram 1004. In some examples, the calibration process may skip a storage location in response to an entry in the planogram 1004 indicating that the storage location is inactive. In some examples, the calibration process may comprise moving the sensor 136 (e.g., the camera) to various target positions and/or collecting the storage location readings 1002 until the storage location readings 1002 include readings for all storage locations, of the storage system 123, that are designated active by the planogram 1004. Alternatively, and/or additionally, the calibration process may comprise collecting the storage location readings 1002 for merely a portion of storage locations of the storage system 123 that are designated active by the planogram 1004. In some examples, one or more readings of the storage location readings 1002 may be performed during one or more item retrieval processes performed by the vending machine 100.

In some examples, the vending machine 100 may comprise a robotic arm (as an alternative to or in addition to) the hopper 134. Alternatively, and/or additionally, the hopper 134 may be coupled to the robotic arm. In some examples, the camera is coupled to the robotic arm and/or the hopper 134 and captures the image 152 while the robotic arm is positioned at a target position relative to the storage location “A, 1”.

In some examples, the sensor 136 may comprise a Radio Frequency Identification (RFID) reader configured to wirelessly read data from RFID tags. In some examples, items of the plurality of items 120 may be associated with corresponding RFID tags that each may identify a corresponding item and/or may be used to determine an item identifier (e.g., the item identifier 1014) and/or other information associated with the corresponding item, such as type, brand, item type, price, model, storage capacity, telecommunication service compatibility, etc. The storage location readings 1002 may comprise readings of data received by the RFID reader from RFID tags associated with the plurality of items 120.

For example, the RFID reader may receive data from a first RFID tag associated with the item 120a (e.g., the RFID tag may be attached to and/or embedded in the item 120a), which may be used to determine the item identifier 1014 associated with the item 120a, the storage location status 1022 associated with the storage location “A, 1” and/or the inventory status 1028 associated with the storage location “A, 1”. In some examples, the RFID reader may determine a quantity of items stored in the storage location “A, 1” by monitoring for and/or detecting a quantity of RFID tags in the storage location (e.g., the quantity of items may be equal to the quantity of RFID tags detected by the RFID reader). The storage location status 1022 may be generated to be indicative of the quantity of items. In some examples, the inventory status 1028 may indicate whether the storage location “A, 1” has a low inventory issue, which may be determined based upon the quantity of items, for example, by comparing the quantity of items with a threshold quantity indicated by the storage location entry 1026 from the planogram 1004. In some examples, the inventory status 1028 may be indicative of low inventory based upon a determination that the quantity of items is less than the threshold quantity.

Alternatively, and/or additionally, the RFID reader may receive data from a second RFID tag associated with the second item 120b (e.g., the RFID tag may be attached to and/or embedded in the second item 120b), which may be used to determine the second item identifier associated with the second item 120b, the second storage location status associated with the storage location “A, 2” and/or the second inventory status associated with the storage location “A, 2”. In some examples, the RFID reader may determine a second quantity of items stored in the storage location “A, 2” by monitoring for and/or detecting a second quantity of RFID tags in the storage location (e.g., the second quantity of items may be equal to the second quantity of RFID tags detected by the RFID reader). The second storage location status may be generated to be indicative of the second quantity of items. In some examples, the second inventory status may indicate whether the storage location “A, 2” has a low inventory issue, which may be determined based upon the second quantity of items, for example, by comparing the second quantity of items with a second threshold quantity indicated by the second storage location entry from the planogram 1004. In some examples, the inventory status 1028 may be indicative of low inventory based upon a determination that the second quantity of items is less than the second threshold quantity.

In some examples, the inventory profile 1008 may be indicative of the plurality of inventory statuses and/or one or more inventory issues (e.g., misplaced item, out-of-stock item, low inventory item, etc.) indicated by one or more of the plurality of inventory statuses. In some examples, the inventory management system 115 may trigger and/or perform one or more corrective actions in response to the inventory profile 1008 and/or one or more inventory statuses being indicative of an inventory issue. The one or more corrective actions may be performed to address the one or more inventory issues.

In some examples, the notification system 131 of the inventory management system 115 may transmit one or more alerts indicative of the one or more inventory issues and/or one or more storage locations associated with the one or more inventory issues to vendor agents associated with the set of vending machines. FIG. 1G illustrates the inventory management system 115 transmitting an alert 1030 to the vendor device 113. In some examples, the alert 1030 may comprise an email alert (sent to an email address of the vendor agent, for example), a text message (sent to a phone number of the vendor agent, for example), a push notification, and/or one or more other types of alerts. In some examples, the alert 1030 may be indicative of the one or more inventory issues. In some examples, the alert 1030 may comprise an auto-calibration report indicative of some and/or all information of the inventory profile 1008.

FIG. 1H illustrates the vending machine administration interface 1032 being displayed on the vendor device 113. In some examples, the vending machine administration interface 1032 may display a representation 1050 of the auto-calibration report comprising indications of the one or more inventory issues associated with the vending machine 100. The representation 1050 may comprise one or more inventory issue representations of the one or more inventory issues, such as an inventory issue representation 1044 indicative of a misplaced item at storage location “A, 1” and/or an inventory issue representation 1046 indicative of an out-of-stock item associated with a storage location “B, 3”. In some examples, the one or more inventory issue representations may comprise selectable inputs for triggering corrective actions to address the one or more inventory issues.

The inventory issue representation 1044 may comprise an image and/or text identifying the item 120a (e.g., a bag of chips with item identifier “CHPS4056”) detected at the storage location “A, 1”, an indication that the item 120a is different than an expected item assigned by the planogram 1004 to the storage location “A, 1”, and/or an image and/or text identifying the expected item (e.g., a bag of pretzels with item identifier “PRTZ5234”). The inventory issue representation 1044 may comprise a service order selectable input 1036 and/or a disregard alert selectable input 1038. In some examples, in response to a selection of the service order selectable input 1036, the inventory management system 115 may allocate one or more resources (e.g., a robot, manpower, replacement items, etc.) to replace the item 120a at the storage location “A, 1” with a replacement item (e.g., a bag of pretzels) corresponding to the item identifier (e.g., “PRTZ5234”) indicated by the storage location entry 1026 of the planogram 1004. For example, the inventory management system 115 may transmit a message with instructions for replacing the item 120a with the replacement item to a vending machine service. The disregard alert selectable input 1038 may be selected if the vendor agent does not want to replace the item 120a with the expected item. In some examples, in response to a selection of the disregard alert selectable input 1038, the inventory management system 115 may update the planogram 1004, for example, by modifying the item identifier (e.g., “PRTZ5234”) indicated by the storage location entry 1026 of the planogram 1004 based upon the item identifier (e.g., “CHPS4056”) indicated by the storage location status 1022 (e.g., the inventory management system 115 may modify the item identifier indicated by the storage location entry 1026 from “PRTZ5234” to “CHPS4056” to reflect that the storage location “A, 1” is assigned to bags of chips with item identifier “CHPS4056” and/or no longer assigned to bags of pretzels with item identifier “PRTZ5234”).

In some examples, the plurality of storage location statuses 1012 may comprise a third storage location status associated with the storage location “B, 3”, which may be determined using one or more of the techniques provided herein with respect to determining the storage location status 1022. The third storage location status may be determined by the reading analysis module 1010 based upon a reading (of the storage location readings 1002) collected by the sensor 136 (e.g., the camera and/or the RFID reader). In some examples, the reading may comprise a third image captured by the camera (when the camera is in a target camera position relative to the storage location “B, 3”, for example). For example, the reading analysis module 1010 (and/or the image processing module 158) may analyze the third image to determine that the storage location “B, 3” is vacant. In some examples, the reading may comprise a sensing result of sensing performed by the RFID reader (when the RFID reader is in a target RFID reader position relative to the storage location “B, 3”, for example). For example, the reading analysis module 1010 may determine that the storage location “B, 3” is vacant based upon the sensing result indicating that there is no detected RFID tag (and/or corresponding item) in the storage location “B, 3”.

The calibration module 1006 may determine a third inventory status of the plurality of inventory statuses based upon the third storage location status and/or the planogram 1004, such as using one or more of the techniques provided herein with respect to determining the inventory status 1028. For example, the third inventory status may be indicative of whether the storage location “B, 3” is associated with an inventory issue, which may be determined by comparing the third storage location status with a third storage location entry (associated with the storage location “B, 3”) from the planogram 1004 to check for a discrepancy (e.g., a difference in vacancy status or item) between the third storage location status and the third storage location entry. The calibration module 1006 may generate the third inventory status to indicate that the storage location “B, 3” is associated with an out-of-stock item based upon a determination that the third storage location status indicates the storage location “B, 3” is vacant and the third storage location entry indicating that the storage location “B, 3” is occupied with a second expected item (e.g., a bag of chips with item identifier “CHPS8032”).

The inventory issue representation 1046 may comprise an indication that storage location “B, 3” is vacant (e.g., out-of-stock) and/or an image and/or text identifying a second expected item (e.g., a bag of chips with item identifier “CHPS8032”) assigned by the planogram 1004 to the storage location “B, 3”. The inventory issue representation 1046 may comprise a service order selectable input 1040 and/or a disregard alert selectable input 1042. In some examples, in response to a selection of the service order selectable input 1040, the inventory management system 115 may allocate one or more resources (e.g., a robot, manpower, replacement items, etc.) to stock the storage location “B, 3” with one or more items corresponding to the second expected item (e.g., one or more bags of chips with item identifier “CHPS8032”). For example, the inventory management system 115 may transmit a message with instructions for stocking the storage location “B, 3” to a vending machine service. The disregard alert selectable input 1042 may be selected if the vendor agent does not want to stock the storage location “B, 3”. In some examples, in response to a selection of the disregard alert selectable input 1042, the inventory management system 115 may update the planogram 1004, for example, by modifying the third storage location entry of the planogram 1004 to indicate the storage location “B, 3” is vacant.

In some examples, the vending machine administration interface 1032 may comprise a planogram selectable input 1048 for accessing an interactive planogram representation 1052 comprising a (current and/or updated) representation of the planogram 1004 associated with the vending machine 100. FIG. 1I illustrates the vending machine administration interface 1032 displaying the interactive planogram representation 1052, for example, in response to a selection of the planogram selectable input 1048. In some examples, the interactive planogram representation 1052 may comprise selectable objects corresponding to storage locations of the vending machine 100, such as a selectable object 1054a corresponding to the storage location “A, 1”, a selectable object 1054b corresponding to the storage location “A, 2”, a selectable object 1054c corresponding to the storage location “B, 3”, etc. In response to a selection of a selectable object of the interactive planogram representation 1052, the vending machine administration interface 1032 may display an interface for modifying a storage location entry, of the planogram 1004, corresponding to a storage location that is associated with the selectable object.

In some examples, each of the selectable objects may comprise a graphical representation (e.g., an image and/or icon) of an item stored in a corresponding storage location, an item identifier of the item, and/or an indication of an inventory issue associated with the corresponding storage location. For example, the selectable object 1054a may comprise an “X” symbol (and/or other symbol) to indicate that the storage location “A, 1” has a misplaced item. In some examples, in response to a selection of the selectable object 1054a, the vending machine administration interface 1032 may display an interface (e.g., the inventory issue representation 1044 and/or a different interface) for modifying the storage location entry 1026 of the planogram 1004 and/or requesting the inventory management system 115 to allocate one or more resources to replace the item 120a at the storage location “A, 1” with a replacement item. In some examples, in response to a selection of the selectable object 1054b, the vending machine administration interface 1032 may display an interface for modifying the second storage location entry, of the planogram 1004, associated with the storage location “A, 2”. In some examples, in response to a selection of the selectable object 1054c, the vending machine administration interface 1032 may display an interface (e.g., the inventory issue representation 1046 and/or a different interface) for modifying the third storage location entry of the planogram 1004 and/or requesting the inventory management system 115 to allocate one or more resources to stock the storage location “B, 3”.

In some examples, the one or more corrective actions may comprise replacing the item 120a at the storage location “A, 1” with a replacement item 1062 (shown in FIG. 1J) corresponding to the item identifier 1014, such as a bag of pretzels with item identifier “PRTZ5234”. Alternatively and/or additionally, the one or more corrective actions may comprise stocking the storage location “B, 3” with an item 1064 (shown in FIG. 1J) corresponding to the third item identifier.

In some examples, a user may use the interface panel 102 to select the third item 120c from among the plurality of items 120. The interface panel 102 may display an item selection interface 114 that allows the user to select the third item 120c. For example, the item selection interface 114 may display a list (e.g., a scrollable list) of items of the plurality of items 120 that are available for purchase. In some examples, the item selection interface 114 may display a grid layout of item options (e.g., selectable graphical objects representative of items of the plurality of items 120), that may each comprise a brief item description and/or item price, enabling the user to visually browse and/or select the third item 120c. In some examples, the item selection interface 114 may present categorized tabs and/or filters, allowing the user to narrow down choices based upon preferences such as item type, brand, price range, etc. In some examples, the item selection interface 114 may incorporate a search function, enabling the user to quickly locate desired items among the plurality of items 120. In some examples, the item selection interface 114 may provide real-time feedback on item availability, highlight promotions or discounts, and/or offer recommendations based upon browsing history of users of the vending machine 100 (and/or other vending machines) and/or popular item selections. In some examples, the vending machine controller 107 may receive (by the user tapping on a purchase button to purchase the third item 120c, for example) a selection of the third item 120c via the item selection interface 114.

In some examples, the interface panel 102 may display a payment interface 118 that allows the user to submit a payment, for example, in compensation for purchasing the third item 120c. The payment interface 118 may display various payment options available to the user, such as credit card, debit card, digital payment services (e.g., payment methods using mobile payment applications and/or digital wallets), cryptocurrency payment services, contactless Near-Field Communication (NFC) payments, visual code-based payments, prepaid balance deductions, cash, etc. In some examples, the payment interface 118 may present selectable inputs (e.g., buttons, icons, etc.) for each payment option (allowing the user to choose a preferred payment option, for example).

In some examples, in response to the user selecting a card-based payment method, the payment interface 118 may display instructions for using an integrated card reader 124 to execute the payment (by inserting a card into the integrated card reader 124, swiping the card using the integrated card reader 124, and/or tapping the card on the integrated card reader 124, for example). In some examples, in response to the user selecting a mobile payment method, the payment interface 118 may generate and/or display a visual code (e.g., QR code and/or other type of code) for scanning using a mobile payment application to facilitate the payment. In some examples, in response to the user selecting a digital wallet payment method, the payment interface 118 may provide guidance for the user to make the payment using a digital wallet (and/or the payment may be automatically withdrawn from the digital wallet). In some examples, in response to the user selecting a cryptocurrency wallet payment method, the payment interface 118 may provide guidance for the user to make the payment using a cryptocurrency wallet (and/or the payment may be automatically withdrawn from the cryptocurrency wallet). In some examples, in response to the user selecting an NFC payment method, the payment interface 118 may prompt the user to hold a device (e.g., an NFC equipped device) near an NFC reader to execute the payment. In some examples, the payment interface 118 may prompt the user to log in to an account associated with a stored payment method. In some examples, the payment interface 118 may display real-time transaction details, such as the total amount due, itemized costs (e.g., item price, activation fees, taxes, etc.), applicable discounts and/or promotions, a remaining balance if a split payment performed, etc.

In some examples, in response to the user submitting the payment and/or receiving confirmation that the payment was successful, the payment interface 118 may display a confirmation message indicating successful payment processing, in some examples along with a selectable input for choosing to be provided with a digital receipt and/or printed receipt (which may be printed using the printer 125, for example).

In some examples, the interface panel 102 (and/or a speaker and/or microphone of the vending machine) may be used to present a conversational interface that may be implemented using a generative Artificial Intelligence (AI) model and/or that may engage in a conversation with the user (e.g., an audio conversation between the user and the generative AI model and/or a chat conversation with chat messages between the user and the generative AI model) that guides the user through one or more acts of selecting the third item 120c and/or submitting the payment.

Embodiments are contemplated in which the third item 120c is selected using a device different than the interface panel 102, such as using a client device (e.g., a smartphone, a tablet, a laptop, etc.) that may be accessible to the user or another user (e.g., a remote user that may submit the order remotely from a different location, such as a different area, city or country, using the client device). For example, an order submission interface may be presented on the device, for example, by a mobile application on the device and/or a webpage displayed by a browser of the device. In some examples, the order submission interface may comprise a conversational interface that may be implemented using the generative AI model and/or that may guide a user through one or more acts of selecting the third item 120c and/or submitting the payment. In some examples, the order submission interface may comprise a second item selection interface (with one or more of the features and/or functionalities of the item selection interface 114, for example) and/or a second payment interface (with one or more of the features and/or functionalities of the computing device 302 payment interface 118, for example). In some examples, an order (e.g., a phone order) with the selection of the third item 120c and/or the payment may be submitted via a call (e.g., a voice call, a video call, etc.) and/or chat with a customer service representative.

In some examples, in response to receiving the selection of the third item 120c and/or the payment (and/or confirmation that the payment was successful), the vending machine 100 may perform an item retrieval process to collect the third item 120c from the storage location “C, 3” and/or transfer the third item 120c to a dispensing location (in the dispensing slot, for example). In some examples, the item retrieval process may be performed using the hopper 134, which may be attached to a post 138 (e.g., a vertical post). In some examples, the driving mechanism and/or the second driving mechanism may move the hopper 134 along a path 130 from a position (e.g., behind the panel 144 of the vending machine 100) to a fourth hopper position relative to the storage location “C, 3”. FIG. 1J illustrates the hopper 134 at the fourth hopper position, in accordance with some embodiments.

In some examples, the hopper 134 may be guided to the fourth hopper position based upon the storage location “C, 3” in which the third item 120c is stored. The vending machine controller 107 may translate the storage location “C, 3” into a movement path (e.g., the path 130) and/or a target hopper position (e.g., the fourth hopper position) for the hopper 134 and/or move the hopper 134 (using the driving mechanism and/or the second driving mechanism, for example) to the fourth hopper position (for collection of the third item 120c) based upon the movement path and/or the target hopper position associated with the storage location “C, 3”.

In some examples, the item retrieval process may comprise transferring (and/or unloading) the third item 120c into an item holding chamber (e.g., an item container and/or basket) defined by the hopper 134 (when and/or after the hopper 134 is at the fourth hopper position, for example). In some examples, the vending machine 100 may comprise a mechanical component that facilitates transfer of the third item 120c into the item holding chamber (e.g., a rotating coil, a helix, a robotic arm, a gripping mechanism, a pusher mechanism, etc., or some combination thereof). In some examples, in response to transferring the third item 120c into the item holding chamber of the hopper 134, the hopper 134 may be moved (using the driving mechanism and/or the second driving mechanism, for example) along a path 168 (shown in FIG. 1K) from the fourth hopper position (e.g., the position of the hopper 134 in front of the third item 120c shown in FIG. 1J) to an item dispensing position (e.g., behind the panel 144 of the vending machine 100) relative to the dispensing slot. In some examples, in response to the hopper 134 reaching the item dispensing position, the third item 120c may be transferred from the hopper 134 (and/or from the item holding chamber defined by the hopper 134) to a dispensing location (in the dispensing slot, for example). In some examples, the third item 120c is accessible to the user when the third item 120c reaches the dispensing location. In some examples, the vending machine 100 may comprise the dispensing slot door 104 (and/or other component) that may obstruct user access to the dispensing location. In some examples, the vending machine controller 107 may engage the dispensing slot door 104 (by opening the dispensing slot door 104, for example) to allow access to the third item 120c.

FIG. 1K illustrates the vending machine 100 after the dispensing slot door 104 is engaged to provide user access to the third item 120c. In some examples, the user may retrieve the third item 120c from the vending machine 100. In some examples, the vending machine 100 may comprise one or more sensors to confirm that the third item 120c was retrieved from the dispensing location. In some examples, the vending machine controller 107 may close the dispensing slot door 104 in response to confirming that the third item 120c was retrieved from the dispensing location.

In some examples, the planogram 1004 is generated by an auto-planogram generation process that uses the storage location readings 1002 and/or the storage location statuses 1012 to auto-generate the planogram 1004. For example, entries of the planogram 1004 corresponding to storage locations may be auto-populated with item identifiers and/or vacancy statuses derived from the storage location readings 1002. For example, the storage location entry 1026 associated with the storage location “A, 1” may be populated with the item identifier 1014 indicated by the storage location status 1022 (derived from the image 152, for example). The second storage location entry associated with the storage location “A, 2” may be populated with the second item identifier (derived from the second image, for example).

In some examples, the third item 120c may comprise a SIM card and/or a SIM-equipped device, such as a device (e.g., a phone, a wearable device, a tablet, an Internet of Things (IoT) device, etc.) equipped with a SIM card and/or an embedded SIM (eSIM). In some examples, the system 101 may comprise an automatic activation system configured to perform an activation process associated with the third item 120c (during the item retrieval process, for example). For example, the activation process may be performed based upon a visual code (e.g., a QR code) of the third item 120c (e.g., the visual code may be identified and/or decoded using an image captured by the camera of the sensor 136). The activation process may comprise registering the SIM card and/or the SIM-equipped device with a telecommunication service provider. The activation process may comprise associating the SIM card and/or the SIM-equipped device with a service plan selected by the user. Plan information of the service plan may be selected using a plan selection interface 116 displayed by the interface panel 102. The activation process may be performed using one or more of the techniques provided in U.S. Patent Application entitled “METHOD AND SYSTEM FOR AUTOMATIC TELECOMMUNICATION SERVICE ACTIVATION OF ITEMS DISPENSED USING VENDING MACHINE”, filed on May 13, 2025 with application Ser. No. 19/206,308, which is incorporated by reference herein in its entirety.

In some examples, the inventory management system 115 and/or the vending machine controller 107 may be implemented by a computer of the vending machine 100 and/or a second computer (e.g., a server) connected to the computer via a network (e.g., the Internet). The computer and/or the second computer, for example, may run an application that displays the item selection interface 114, the plan selection interface 116 and/or the payment interface 118 on the interface panel 102 on the interface panel 102.

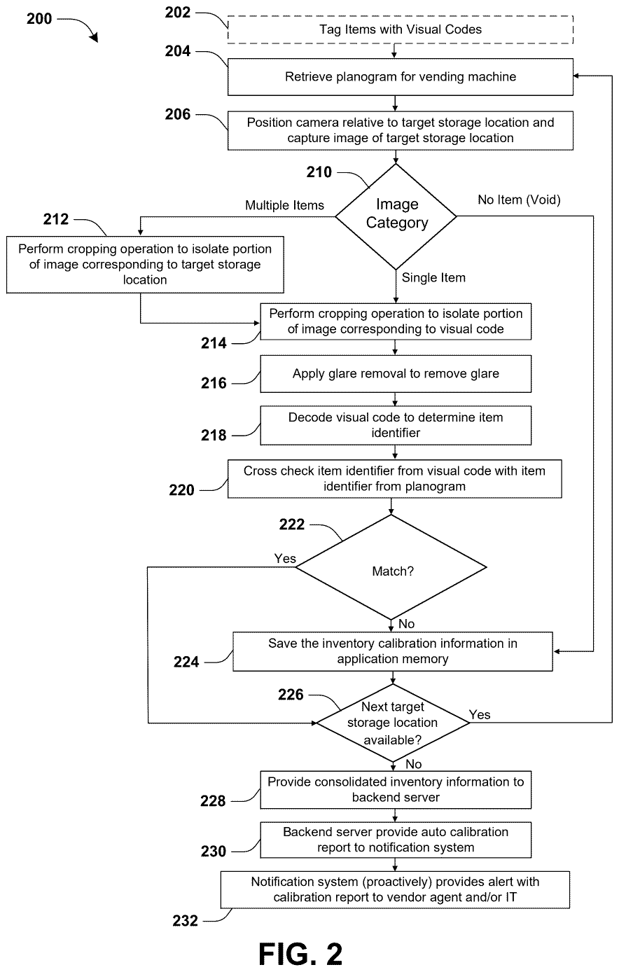

An embodiment of providing inventory management services for the vending machine 100 is illustrated by an exemplary method 200 of FIG. 2. At 202, items stored in the vending machine 100 may be tagged with visual codes (e.g., QR codes). A calibration process for calibrating one or more storage locations of the vending machine 100 may be triggered. At 204, the planogram 1004 (e.g., an updated and/or current version of the planogram 1004) associated with the vending machine 100 may be retrieved from the inventory data store 127 for use in performing the calibration process. A target storage location (e.g., an initial storage location to be scanned using the sensor 136 to collect a reading for the calibration process, or a subsequent storage location to be scanned after the initial storage location) may be determined based upon the planogram 1004. At 206, the camera 136 may be positioned relative to the target storage location and/or may be used to capture an image (e.g., the image 152) of the target storage location. At 210, the image may be analyzed to determine an image category of the image. At 212, in response to the image category indicating that the image has a view of multiple items, a cropping operation may be performed at 212 to isolate a portion of the image that corresponds to the target storage location. For example, the cropping operation at 212 may be performed by the selective cropping module 154 to generate a cropped image (e.g., the cropped image 156) with the portion of the image that corresponds to the target storage location. At 214, a second cropping operation may be performed (by the image processing module 158, for example) on the image (in response to the image category indicating that the image has a view of a single item, for example) or the cropped image (in response to performing the cropping operation at 212, for example) to isolate a portion of the image that corresponds to a visual code (e.g., the visual code 146) attached to an item. At 216, glare removal may be applied (by the image processing module 158, for example) to the isolated image of the visual code to generate an improved image. At 218, the improved image may be decoded (by the image processing module 158, for example) to determine an item identifier (e.g., the item identifier 1014) associated with the item. At 220, the decoded item identifier from the visual code may be cross-checked against an expected item identifier indicated by an entry (e.g., the storage location entry 1026) of the planogram 1004. At 222, the calibration module 1006 may determine whether the decoded item identifier matches the expected item identifier. At 224, inventory calibration information identifying an inventory issue (e.g., misplaced item, out-of-stock item, etc.) may be stored in application memory in response to determining at 222 that the decoded item identifier does not match the expected item identifier or in response to the image category indicating that the image has a view of no item and/or is void. At 226, a check may be performed to determine whether additional storage locations (e.g., active storage locations) remain to be scanned in the calibration process. In response to identifying an additional storage location, the method 200 may return to act 206 to process the additional storage location. In response to processing some or all active storage locations of the vending machine 100, consolidated inventory calibration information (e.g., the inventory profile 1008) indicative of one or more inventory issues associated with the vending machine 100 may be provided to a backend server of the inventory management system 115 at 228. At 230, the backend server may generate an auto-calibration report based upon the inventory calibration information and/or may provide the auto-calibration report to the notification system 131, which may (proactively, for example) provide an alert (e.g., the alert 1030) with the auto-calibration report to a vendor agent and/or an IT agent at 232.

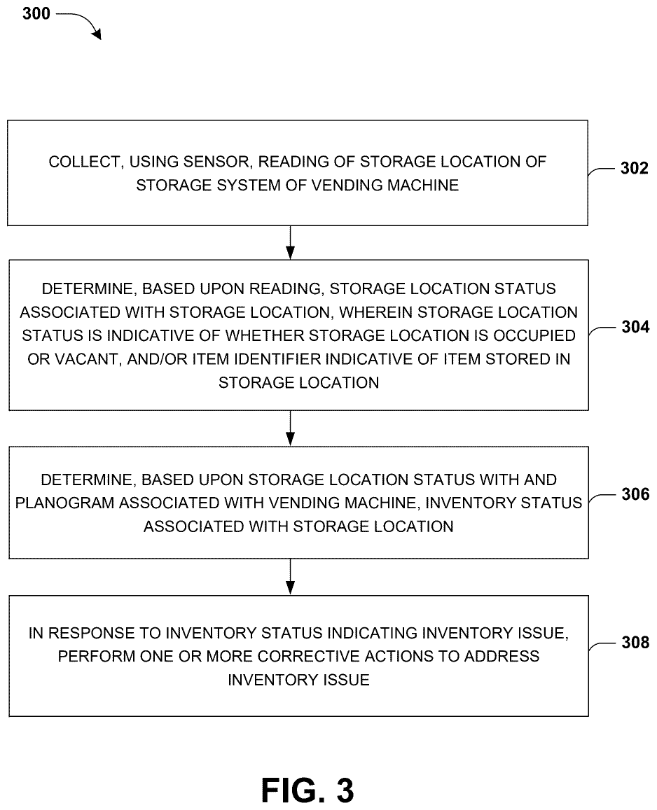

An embodiment of providing inventory management services for a vending machine (e.g., the vending machine 100) is illustrated by an exemplary method 300 of FIG. 3. At 302, a reading (e.g., the image 152 and/or RFID data) of a storage location of a storage system of the vending machine may be collected using a sensor (e.g., the sensor 136). At 304, a storage location status (e.g., the storage location status 1022) associated with the storage location may be determined based upon the reading. The storage location status may be indicative of whether the storage location is occupied or vacant, and/or an item identifier indicative of an item stored in the storage location. At 306, an inventory status (e.g., the inventory status 1028) associated with the storage location may be determined based upon the storage location status and/or a planogram (e.g., the planogram 1004) associated with the vending machine. At 308, in response to the inventory status indicating an inventory issue, one or more corrective actions may be performed to address the inventory issue.

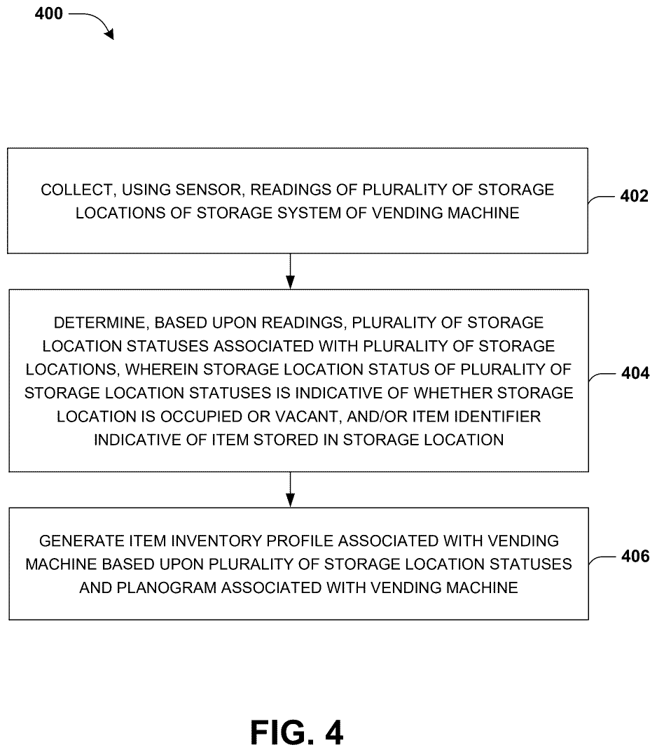

An embodiment of providing inventory management services for a vending machine (e.g., the vending machine 100) is illustrated by an exemplary method 400 of FIG. 4. At 402, readings (e.g., the storage location readings 1002) of a plurality of storage locations of a storage system of the vending machine may be collected using a sensor (e.g., the sensor 136). At 404, a plurality of storage location statuses (e.g., the plurality of storage location statuses 1012) associated with the plurality of storage locations may be determined based upon the readings. A storage location status of the plurality of storage location statuses may be indicative of whether a storage location is occupied or vacant, and/or an item identifier indicative of an item stored in the storage location. At 406, an inventory profile (e.g., the inventory profile 1008) associated with the vending machine may be generated based upon the plurality of storage location statuses and a planogram (e.g., the planogram 1004) associated with the vending machine.

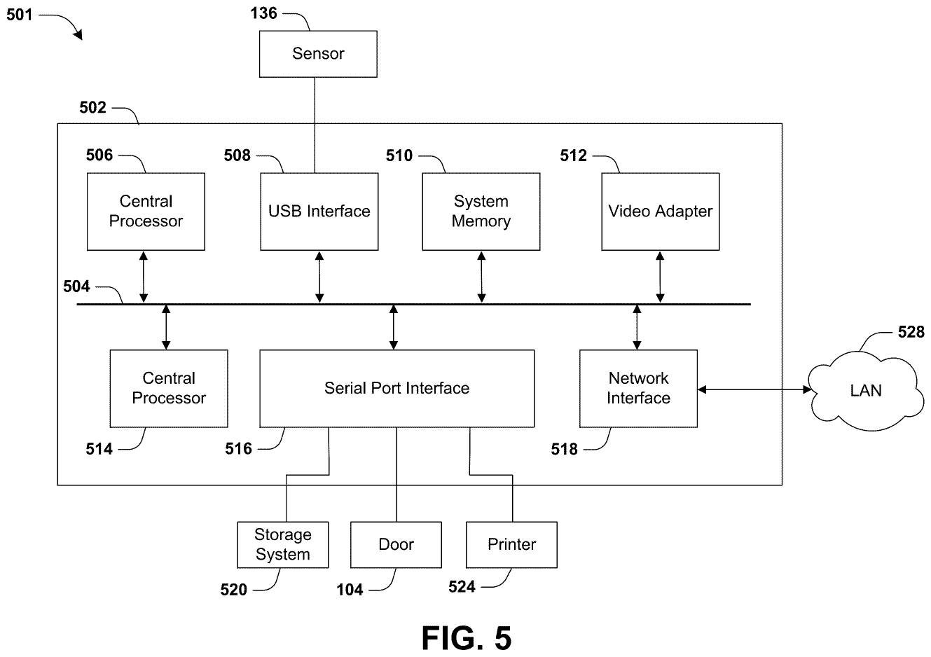

FIG. 5 illustrates a system 501 used to facilitate one or more operations of the vending machine 100, such as item and/or plan selection, payment processing, service activation for an item, and/or product dispensing. In some examples, the system 501 may comprise a computing device 502 (e.g., the vending machine controller 107 and/or the computer of the vending machine 100) that may coordinate and/or execute one or more operations of the vending machine 100. The computing device 502 may comprise a central processor 506 and/or a second central processor 514, which may be responsible for executing software instructions, managing input and output operations, overseeing overall functionality of the computing device 502, etc. The second central processor 514 may be utilized for handling specialized tasks independently from the central processor 506. For example, the central processor 506 may be used for general computing functions, while the second central processor 514 may be used for handling real-time operations related to controlling one or more components of the vending machine 100, such as the storage system 123, the dispensing slot door 104 of the vending machine 100, the interface panel 102, and/or the printer 125 of the vending machine 100 (e.g., the printer 125 may be used for printing receipts and/or other documents). In some examples, having multiple central processors in the same computing device 502 may enhance performance by distributing processing tasks, ensuring that functions such as user interactions and/or payment processing do not interfere with hardware control operations, for example. Alternatively and/or additionally, computational tasks may be divided between the central processor 506 and the second central processor 514 may enhance system efficiency, such as by allowing different operations to be processed in parallel, thereby reducing delays and/or improving overall performance associated with the vending machine 100.

In some examples, the system 501 may comprise system memory 510 that may store one or more applications and/or instructions executed by the central processor 506 and/or the second central processor 514 to control functionality of the vending machine 100. The system memory 510 may store one or more configuration settings, such as network parameters, device identifiers, and/or communication protocols used to interface with external systems, such as payment processors, inventory management databases (e.g., the inventory data store 127), and/or item activation services. The system memory 510 may store item inventory data, including details about the plurality of items 120 available for selection and/or purchase, such as item descriptions, prices, availability status, and/or associated service plans. The system memory 510 may store user interaction data, such as selection history, payment transactions, and/or preferences, which may be used to personalize the item selection interface 114 and/or the plan selection interface 116 for the user. The system memory 510 may temporarily store data related to in-progress transactions, network communications, and/or real-time processing tasks performed by the vending machine 100, and/or may delete the temporarily stored data in response to determining that the temporarily stored data is no longer needed for the in-progress transactions, network communications, and/or real-time processing tasks.

In some examples, the system 501 may comprise a bus 504, which may interconnect various components within the computing device 502 to facilitate data transfer between the components, such as the central processor 506, the second central processor 514, a USB interface 508, the system memory 510, a video adapter 512, a network interface 518, and/or a serial port interface 516. The computing device 502 may be configured to control the camera. The sensor 136 may be connected to the bus 504 and/or the computing device 502 via the USB interface 508 and/or one or more other interface types. The network interface 518 of the system 501 may provide a connection between the computing device 502 and a Local Area Network (LAN) 528 to facilitate communication between the computing device 502 and external networks and/or cloud-based services. The serial port interface 516 (and/or one or more other interface types) may provide a connection between the computing device 502 and the storage system 123, the dispensing slot door 104, and/or the printer 125.

Implementation of at least some of the disclosed subject matter may lead to benefits including, but not limited to, reduced (and/or zero) manual effort in comparison with some vending machine inventory management services that involve manual checks for misplaced items using a printed list of items and their designated storage locations, requiring a vendor to physically match each item to its intended storage location, or some vending machine inventory management services that rely on indirect monitoring, such that a vendor agent is not notified when an item is out-of-stock (e.g., the vendor may need to instead routinely check the vending machine).

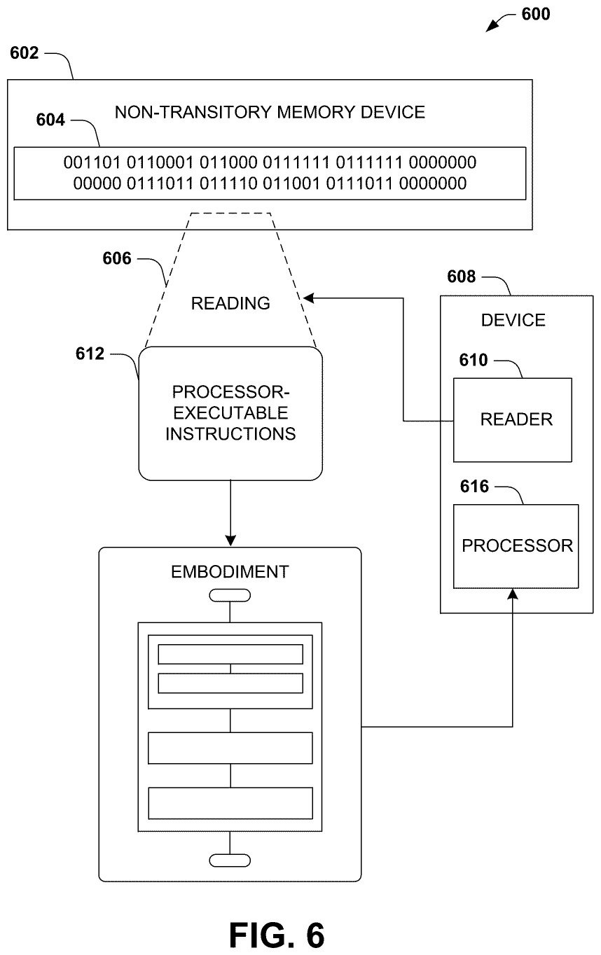

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random-access memory (SRAM), dynamic random-access memory (DRAM), and/or synchronous dynamic random-access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, at least some of the example method 300 of FIG. 3, and/or at least some of the example method 400 of FIG. 4, for example. In some embodiments, the processor-executable instructions 612 are configured to cause implementation of a system, such as at least some of the example system 101 of FIGS. 1A-1K and/or at least some of the example system 501 of FIG. 5, for example.

In some embodiments, the systems and methods described herein may be adapted to address one or more disbursement issues that may arise after a user has provided payment for a selected item. For example, a selected item may be unavailable because a storage location is empty (e.g., out of stock), or an item may be misaligned or fallen within its storage location, preventing the hopper or other retrieval mechanism from dispensing it. In other examples, a visual code (e.g., a QR code) on an item may be damaged or obscured, preventing a confirmation scan from completing successfully. In such scenarios, even though payment has been accepted, the vending machine is unable to dispense the product. The system may be configured to automatically detect such failures and trigger a reversal of the payment made by the user, providing a message to the user explaining the malfunction and the pending refund.

This process may leverage one or more of the components described previously, such as the vending machine 100, vending machine controller 107, sensor 136 (e.g., a camera coupled to the hopper 134), and inventory management system 115. Upon receiving a user's selection and successful payment, the vending machine controller 107 may command the hopper 134 to move to the coordinates (e.g., row and column) of the selected item. The camera (e.g., sensor 136) on the hopper 134 may then capture an image of the target storage location.

The system then initiates a series of checks using computer vision techniques. First, the system may attempt to scan a visual code, such as a QR code, on the product. If this scan fails (e.g., due to a damaged code or no code being visible), the system may proceed to a second check. In this check, a computer vision algorithm analyzes the captured image to determine if a product is physically present in the storage location. If no product is detected, it may be determined that the location is out of stock. If a product is detected but the QR code was unreadable, the system may proceed to a third check.

This third check may involve analyzing the alignment of the product. Using computer vision, the system may identify the bounding box of the product in the image and compare its coordinates and dimensions to a set of expected or acceptable bounding box parameters for that storage location. If the product's bounding box is determined to be inaccurate (e.g., tilted, shifted, or indicating the item has fallen), the system may determine that the product is misaligned and cannot be safely dispensed.

In any of these failure cases (e.g., out of stock, unreadable code where the item is present but alignment cannot be confirmed, or confirmed misalignment), the vending machine controller 107 may be configured to halt the dispensing process. Concurrently, the controller 107 may transmit a payment reversal request to the inventory management system 115 or a connected payment processing system to refund the user's transaction. The controller 107 may also display a message on the user interface 111, informing the user of the malfunction and that their payment is being returned. Furthermore, a notification may be sent to a backend system or a vendor agent (e.g., via vendor device 113) detailing the specific issue and the coordinates of the affected rack, facilitating timely maintenance. If all checks pass successfully (e.g., the QR code is scanned or the product's presence and alignment are verified by computer vision), the system proceeds with commanding the hopper 134 to dispense the product to the user.

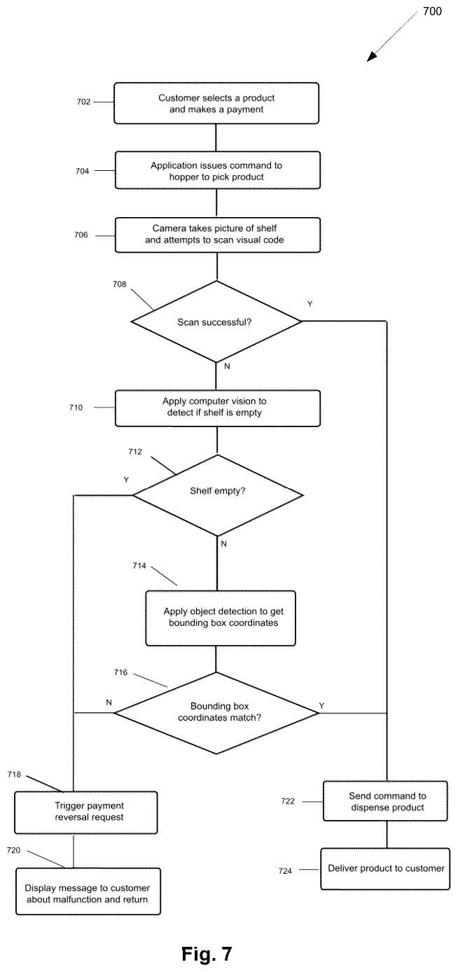

An embodiment of providing for automatic payment reversal is illustrated by an exemplary method 700 of FIG. 7. At 702, a customer selects a product and makes a payment in the vending machine. At 704, the vending machine application issues a command to the hopper to pick the product from the corresponding rack using its coordinates. At 706, the camera mounted on the hopper takes a picture of the rack location and attempts to scan a visual code on the product. A determination is made at 708 as to whether the scan was successful. If the scan is successful, the method proceeds to cause the selected product to be dispensed to the hopper (block 722) and delivered to the customer (block 724). If the scan was not successful, the method proceeds to 710, where a computer vision algorithm is applied to detect if the rack is empty or has a product. If the rack is empty (block 712), the method proceeds have a payment reversal request be triggered to the vending machine application (block 718). At 720, the application displays a message to the customer about the malfunction and informs them about the payment return. If the rack is not empty, the method proceeds to 714.

At 714, an object detection technique is applied to get the bounding box coordinates for the product (e.g., using the object detection techniques described above). At 716, a determination is made as to whether the bounding box coordinates match expected coordinates. If the coordinates match, the method proceeds to 722 to dispense the product (as described above). If the bounding box coordinates do not match at 716, a payment reversal request is triggered to the vending machine application (block 718) as noted above.

In some embodiments, the systems and methods described herein may be adapted to provide for the automatic creation of a vending machine planogram. Traditionally, creating a planogram is a manual process where an administrator uses a portal to map specific products to each rack and slot in the vending machine, and a vendor then stocks the machine according to the generated mapping (e.g., a printed diagram). This process can be time-consuming, labor-intensive, and prone to error. The automatic planogram creation embodiment streamlines this by allowing a vendor to load products into the vending machine in any arrangement (freeform loading) and then initiating an automated process to generate the planogram.

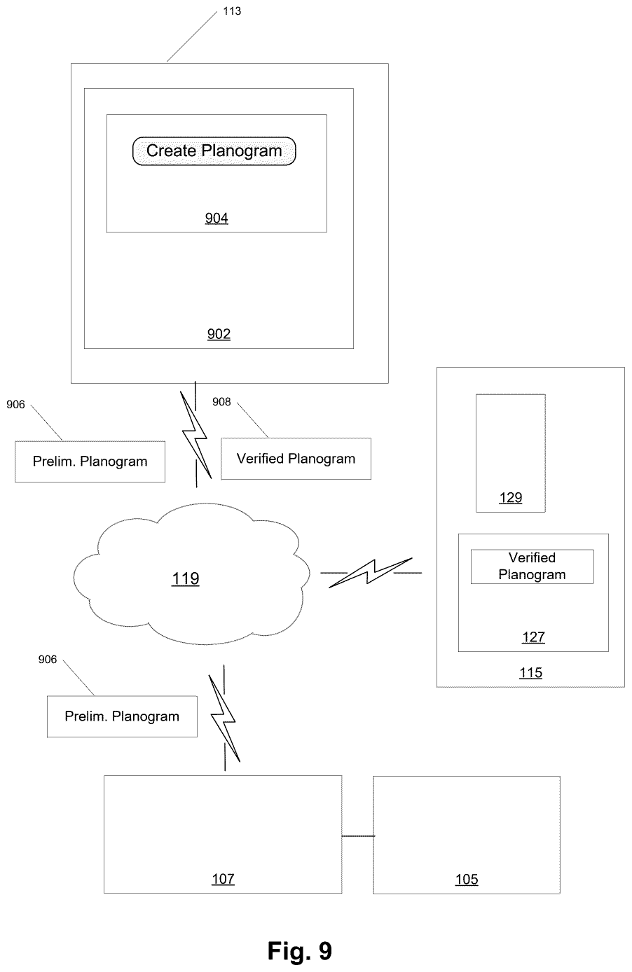

As illustrated in the system diagram of FIG. 9, this process may be managed by a vendor agent using an application 902 running on the vendor device 113. The application 902 may be (or include) a component of the vending machine administration platform provided by the vending machine administration portal 129. For example, application 902 may be deployable to device 113, and include communication facilities to allow communication with vending machine administration portal 129 to send/receive the information described herein. The vendor agent may initiate the process by selecting an “Auto Create Planogram” function 904 within the application 902. This sends an instruction to the vending machine controller 107 to begin a scanning process.

Once triggered, the vending machine controller 107 may engage the vending machine hardware to generate a planogram. For example, the sensor 136 (e.g., a camera) may be used to systematically scan the storage system 123. Sensor 136 is attached to hopper 134, which may move from one storage location (e.g., rack or slot) to the next in a predefined sequence, such as starting at the top-left corner and moving across each row. At each storage location, the camera captures an image. The system, using one or more computer vision algorithms, first analyzes the image to determine if the location is empty. If it is not empty, the system attempts to scan and decrypt a visual code, such as a QR code, on the product to obtain product details (e.g., an item identifier like a SKU). In addition to identifying the product, the system may also determine the physical space the product occupies. By analyzing the bounding box of the product in the captured image, the system can determine if the product occupies a single standard-sized rack or extends across multiple racks (e.g., an extended size product occupying the space of two racks). This process continues until all potential storage locations in the vending machine have been scanned.

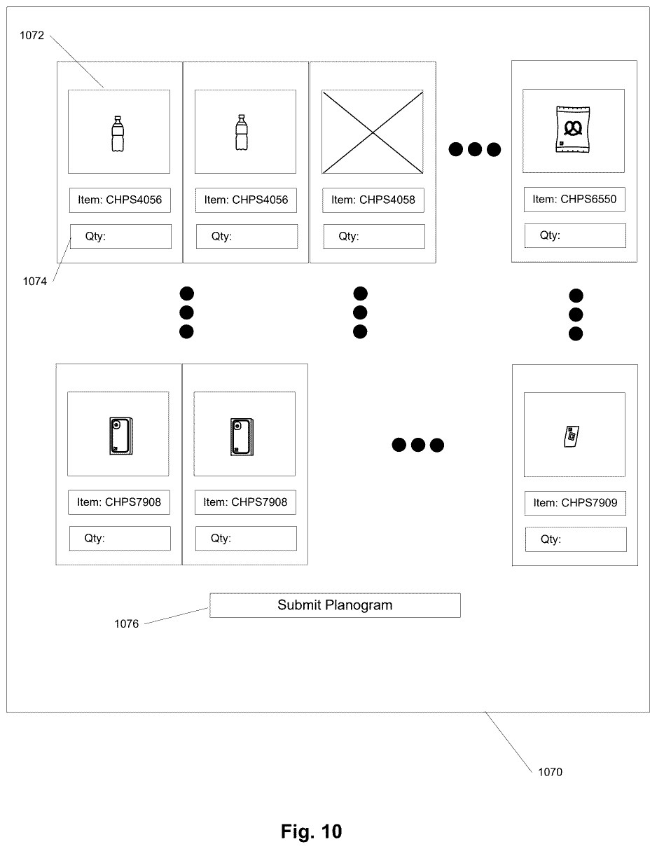

Upon completion of the scanning sequence, the vending machine controller 107 transmits the collected preliminary planogram data 906 to the application 902 on the device 113. As illustrated in FIG. 10, the vendor application 902 may present an interactive user interface 1070 that visually represents the scanned planogram. This interface 1070 may display a grid corresponding to the storage locations 123, showing a representation 1072 of the item identified in each slot, such as an image or item identifier (or no identifier if the slot is empty). The interface 1070 may also include an input field 1074 for each occupied slot, allowing the vendor to enter the quantity of items stocked in that location. Should the automated scan result in an error, such as misidentifying an item, the vendor may select the incorrect entry and choose a correct item from a searchable product catalog within the app or manually enter a correct identifier. The vendor can review the entire preliminary planogram, make necessary corrections to item identifiers or sizes, and input all quantities.

Once the vendor is satisfied with the accuracy of the planogram displayed in the application, they can select a confirmation or upload button 1076. In response, the vendor application 902 transmits the final, user-verified planogram data 908 to the inventory management system 115. The inventory management system 115 then processes this data to formally create and store the new, accurate planogram in the inventory data store 127.

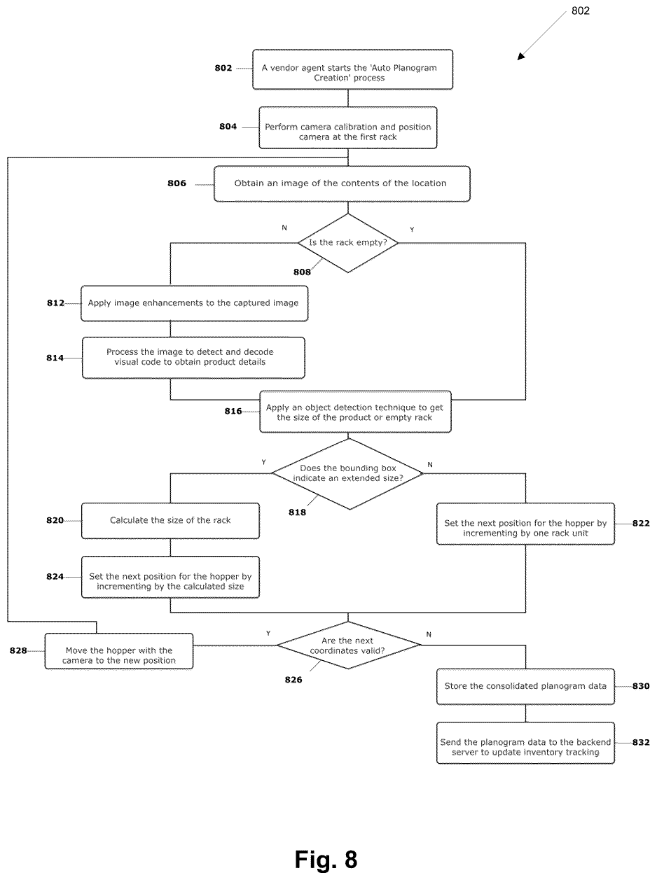

An embodiment of providing for automatic planogram creation is illustrated by an exemplary method 800 of FIG. 8. The method assumes a vendor has loaded the necessary products into the vending machine. At 802, a vendor agent starts the “Auto Planogram Creation” process, such as through an application executing on a vendor device (as noted above). At 804, in some implementations, the system may perform camera calibration, and may position the camera at the first rack and preparing to iterate through all rack/slot locations.

At each location (block 806), the system uses the camera to obtain an image of the contents of the location. It determines if the rack is empty (block 808). If it is not empty, the method may (in some implementations) apply image enhancements to the captured image (block 812), such as a glare removal algorithm. At 814, the image is processed to detect a visual code (e.g., QR code), and the code is decoded to obtain product details, which are saved in memory for the current location.

At 816, an object detection technique is applied to get the size of the product at the location (or if the location was determined to be empty, the size of the empty rack). For example, coordinates for a bounding box of the product (or the empty rack) may be determined from the captured image. A determination is made at 818 if the bounding box indicates an extended size e.g., a product that uses two racks, or a rack with a larger size than normal. If it is not an extended size, the next position for the hopper is set by incrementing the current position by one rack unit at 822. If it is an extended size, the size of the rack is calculated (e.g., 2x or 3x) at 820, and the next position for the hopper is set by incrementing by that size at 824.

After setting the next position, a check is performed at 826 to determine if the next coordinates are valid (i.e., if there are more racks to scan). If the coordinates are valid, the hopper with camera is moved to the new position at 826, and the method loops back to 808 to process the new location. If the coordinates are not valid, meaning all racks have been scanned, the consolidated planogram data is stored (block 830). In some embodiments, the planogram data is sent to the vendor application for review. The planogram data may be sent to the backend server (block 832)—from the vending machine and/or from the application on the vendor device—to allow the backend server to update the inventory tracking of the vending machine using the product details and/or locations.

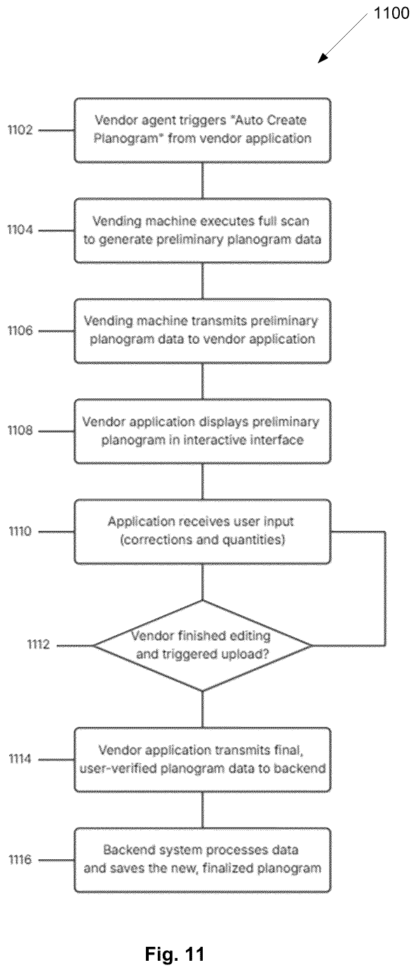

An expanded embodiment of providing for automatic planogram creation with vendor interaction is illustrated by an exemplary method 1100 of FIG. 11. At 1102, a vendor agent, after stocking the vending machine, triggers an “Auto Create Planogram” command from a vendor application on a vendor device. At 1104, the vending machine executes a full scan of all storage locations, using a camera to identify items and their sizes, thereby generating preliminary planogram data. At 1106, the vending machine transmits this preliminary planogram data to the vendor application.

At 1108, the vendor application displays the preliminary planogram in an interactive interface, showing the identified items and their locations. At 1110, the application receives user input from the vendor agent. This input may include corrections to any misidentified items and the addition of item quantities for each stocked location. A determination is made at 1112 as to whether the vendor has finished editing and has triggered the final upload. If not, the method waits at 1110 to receive further user input. If the vendor triggers the upload, the method proceeds to 1114. At 1114, the vendor application transmits the final, user-verified planogram data, including quantities, to the backend inventory management system. At 1116, the backend system processes the data and saves the new, finalized planogram.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some and/or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
initiating, in response to an instruction, an automated planogram generation process for a vending machine, the vending machine comprising a storage system with a plurality of storage locations and an image sensor coupled to a movable component;
executing, as part of the automated planogram generation process, a scanning sequence, the scanning sequence comprising:
iteratively moving the movable component to position the image sensor relative to each of a plurality of storage locations; and
at each of the plurality of storage locations:
collecting, using the sensor, an image of the storage location;
determining, based on the image, a location status for the storage location, the location status indicating whether the storage location is occupied by an item; and
in response to the location status indicating the storage location is occupied by the item, determining, based on the image, an item identifier and an item size for the item;
generating a planogram for the vending machine, wherein the planogram maps the determined item identifier to corresponding coordinates of the storage location for each occupied storage location; and
storing the generated planogram in a data store.

2. The method of claim 1, wherein determining the item identifier comprises:
analyzing the image to identify a visual code on the item; and
decoding the visual code to determine the item identifier.

3. The method of claim 2, wherein the visual code is a Quick Response (QR) code.

4. The method of claim 1, wherein determining the item size comprises:
applying an object detection algorithm to the image to determine a bounding box for the item; and
determining the item size based on one or more dimensions of the bounding box relative to a size of the storage location.

5. The method of claim 4, wherein the item size indicates a quantity of storage locations occupied by the item.

6. The method of claim 1, the scanning sequence further comprising:
determining the item size indicates the item occupies more than one storage location; and
adjusting a next storage location to be scanned to skip one or more adjacent storage locations determined to be occupied by the item.

7. The method of claim 1, wherein the movable component is a hopper configured to retrieve items from the storage system.

8. The method of claim 1, further comprising:
transmitting the generated planogram to a backend server communicatively coupled to the vending machine.

9. The method of claim 1, wherein the instruction is received from an application executing on a remotely located device, and the method further comprises:
transmitting the generated planogram to the application, to allow a user of the application to review the generated planogram and provide to a backend server.

10. A system comprising:
a storage system with a plurality of storage locations;
a movable component;
a camera coupled to the movable component; and
a processor coupled to memory; the processor configured to execute instructions from the memory to perform operations comprising:
initiating, in response to an instruction, an automated planogram generation process for a vending machine;
executing, as part of the automated planogram generation process, a scanning sequence, the scanning sequence comprising:
iteratively moving the movable component to position the sensor relative to each of a plurality of storage locations; and
at each of the plurality of storage locations:
collecting, using the camera, an image of the storage location;
determining, based on the image, a location status for the storage location, the location status indicating whether the storage location is occupied by an item; and
in response to the location status indicating the storage location is occupied by the item, determining, based on the image, an item identifier and an item size for the item;
generating a planogram for the vending machine, wherein the planogram maps the determined item identifier and the determined item size to corresponding coordinates of the storage location for each occupied storage location; and
storing the generated planogram in a data store.

11. The system of claim 10, wherein determining the item size comprises:
applying an object detection algorithm to the image to determine a bounding box for the item; and
determining the item size based on one or more dimensions of the bounding box, wherein the item size indicates a quantity of storage locations occupied by the item.

12. The system of claim 10, the operations for the scanning sequence further comprising:
determining the item size indicates the item occupies more than one storage location; and
adjusting a next storage location to be scanned to skip one or more adjacent storage locations determined to be occupied by the item.

13. The system of claim 10, wherein the movable component is a hopper configured to retrieve items from the storage system, and the camera is fixed to the hopper.

14. The system of claim 10, the operations further comprising:
transmitting the generated planogram to a backend server, wherein the backend server makes the planogram available to an administration portal.

15. The system of claim 10, wherein the instruction is received from an application executing on a remotely located device, and the operations further comprising:
transmitting the generated planogram to the application, to allow a user of the application to review the generated planogram and provide to a backend server.

16. A non-transitory computer-readable medium storing instructions for an application that, when executed by a processor of a device, cause the processor to perform operations, the operations comprising:
transmitting, to a vending machine, an instruction to initiate an automated planogram generation process, wherein the automated planogram generation process causes the vending machine to generate preliminary planogram data by scanning a plurality of storage locations;
receiving, from the vending machine, the preliminary planogram data;
displaying, in a user interface on the device, a representation of the preliminary planogram data;
receiving user input modifying the preliminary planogram data to generate final planogram data; and
transmitting the final planogram data to a backend server.

17. The non-transitory computer-readable medium of claim 16, wherein the user input comprises an item quantity for at least one occupied storage location identified in the preliminary planogram data.

18. The non-transitory computer-readable medium of claim 16, wherein the user input comprises a correction to an item identifier for at least one occupied storage location identified in the preliminary planogram data.

19. The non-transitory computer-readable medium of claim 16, wherein displaying the representation of the preliminary planogram data comprises displaying a grid corresponding to the plurality of storage locations, the grid indicating an item identifier for each occupied storage location.

20. The non-transitory computer-readable medium of claim 19, wherein the user interface includes an input field associated with each occupied storage location for receiving an item quantity.
